(19) United States
(12) Patent Application Publication
(10) Pub. No.: US 2026/0300406 A1
(43) Pub. Date: Oct. 1, 2026

(54) Method for Automatically Classifying Data Items

(71) Applicant: Varonis Systems, Inc., New York, NY (US)

(72) Inventors: Amit Cohen, Kfar-Saba (IL); John Eugene Neystadt, Kfar-Saba (IL); Miri Brusilovsky, Netanya (IL)

(21) Appl. No.: 19/093,453

(22) Filed: Mar. 28, 2025

(51) Int. Cl. G06F 16/906

(52) U.S. Cl. CPC G06F 16/906

(57) ABSTRACT

Broadly speaking, the present techniques provide an automatic way of classifying data items within an environment (e.g. a business, workplace, organisation, etc.). This is advantageous over existing techniques which require manual classification of data items, which is time consuming in environments where hundreds of new data items may be generated or modified in a day or week. The present techniques use the content of a data item together with metadata associated with the data item to classify the data item, and thereby label the data item.

### FIELD

The present application generally relates to a method for automatically classifying data items within an environment.

### BACKGROUND

Many organisations have policies which control actions that can be performed using or with respect to data items within the organisations. These policies require the data items to be labelled in order to enforce data loss prevention and access control policies. For example, organisations may have a policy to retain all emails sent and received by a person within the organisation for five years, after which they can be deleted. Similarly, organisations may have a policy that prevents certain data items from being transmitted outside of the organisation, or which controls who can access the data items within the organisation, or which controls how long data items should be retained before they can be deleted/purged. Therefore, labelling of these data items is essential. Manually labelling this data is not scalable. With huge volumes of digital data items being generated within organisations on a yearly and even daily basis, it is desirable to automate the labelling of data items (thereby enabling automatic application of such policies to the labelled data items). However, automatic labelling often relies on predetermined keywords or rules which may change overtime in the real world. These existing methods of data labelling can be slow to implement, resulting in the prolonged exposure of sensitive data, as documents may remain unlabelled or be mislabelled. It is desirable to address the limitations of current approaches, namely the reliance on predefined keywords or rules.

The present applicant has therefore recognised the need for an improved way to automatically label data items within an organisation.

### SUMMARY

In a first approach of the present techniques, there is provided a computer-implemented method for autonomously classifying data items within an environment, the method comprising: obtaining, from a data source within the environment, a data item that is newly created or newly modified; generating at least one embedding vector for the data item, wherein the at least one embedding vector represents content of the data item; obtaining metadata for the data item; generating at least one classification label for the data item together with an associated confidence level for each classification label, by processing the generated at least one embedding vector and obtained metadata using a trained machine learning, ML, model; determining whether the associated confidence level is greater than or equal to a pre-defined confidence level; and applying the generated at least one classification label to the data item when the generated at least one classification label has an associated confidence level that is greater than or equal to the pre-defined confidence level.

The pre-defined confidence level may be specified for each environment. This means that different environments (e.g. organisations, or departments within organisations) can have different confidence levels. For example, environments with strict policies on data management and data loss prevention (e.g. government organisations, military organisations, or organisations conducting highly sensitive research and development) may want a higher confidence level than those organisations where data management is less critical.

Advantageously, the present techniques provide a way to automatically classify data items within an environment (e.g. a business, workplace, organisation, department within an organisation, etc.). This is advantageous over existing techniques that require manual classification of data items, which is time consuming in environments where hundreds of new data items may be generated in a day or week. As noted above, the present techniques make use of a machine learning model and a large language model to automatically determine the relevant classification label(s) for any data item.

In some cases, the automatic classification may be used to automatically retrieve at least one data management policy to be applied to data items. The data management policy may be any security and/or data retention policy. For example, the data management policy may be a policy that prevents certain data items from being transmitted outside of the organisation, or that controls who can access the data items within the organisation, or that controls how long data items should be retained before they can be deleted/purged, or moved from primary storage to secondary or tertiary storage. The data management policy may be used to implement national or regional regulation or law, such as the European Union's General Data Protection Regulation (GDPR), or the USA's Data Privacy Protection laws.

The term “newly created data item” is used to mean any data item that has been created and added to the data source since the previous time the classification method was performed. The term “newly modified data item” is used to mean any data item that was already in the data source the previous time the classification method was performed but which has since been modified in some way. The newly modified data item may already have at least one label. However, the modifications to the data item may mean the label(s) is no longer correct/accurate—this is why newly modified data items are also processed again using the present method.

The present techniques are also advantageous over existing techniques that automatically classify data items using rules and regular expression matching, because relevant rules and regular expressions are difficult to create for specific environments and can suffer from false positives. The present techniques do not classify data items by applying rigid classification rules or by pattern/expression matching. Instead. the present techniques use embeddings to determine the semantic meaning of content of the data item to thereby determine the most appropriate classification label. This is useful because even if a data item contains a certain phrase which might suggest that a certain classification label is relevant, the overall meaning of the content of the data item may indicate that a different classification label is more relevant. For example, an email may contain one phrase that relates to finance (suggesting the email should be classified with a “finance” label), but the overall meaning of the whole email may be about an employee's performance, so the email should be classified with a “human resources” label. Standard rules-based on expression matching techniques are unable to pick-up on this important difference between phrases and overall semantic meaning.

In addition to using embeddings, the present techniques also use metadata associated with each data item to determine the most appropriate classification label. This is advantageous because the metadata may provide further useful information that determines how a data item should be labelled. Thus, the combination of the embedding vector(s) for the semantic content of the data item and the metadata for the data item allows better, more accurate labelling of data items. This is illustrated by the following examples.

For example, data item A may be a document containing sensitive financial information, and the associated metadata may show that the document has been generated by the finance department. Generally, documents generated by the finance department are considered confidential in this particular environment, and since the document also contains sensitive information, there is a strong case for considering the data item A to be confidential. In this case, the data item A may be labelled with a “confidential” label.

In another example, data item B may be a document containing information about suppliers and procurement, and the associated metadata may show that the document has been generated by the finance department. In this case, although the document does not contain sensitive information, since documents generated by the finance department are usually considered confidential, there is a strong case for data item B to be considered confidential. Thus, in this case, data item B may be labelled with a “confidential” label. However, if only the content of data item B was used to determine the label, the outcome (i.e. label) might be different. This could be problematic as it could lead to mis-labelling, and therefore, the wrong data management policies being applied to the data item.

In another example, data item C may be a document containing information about salaries for employees in a certain team, and the associated metadata may show that the document has been generated by the engineering department. Generally, documents generated by the engineering department are considered to be technical, non-confidential documents in this particular environment. However, since the document contains sensitive information (salaries), there is a strong case for considering the data item A to be confidential. In this case, the data item C may be labelled with a “confidential” label. If only the metadata of data item C was used to determine the label, the outcome (i.e. label) might be different. This could be problematic as it could lead to mis-labelling, and therefore, the wrong data management policies being applied to the data item.

The data items are obtained from at least one data source within the environment. The or each data source may be any computing device within the environment. Examples of computing devices include laptops, desktop computers, smartphones, servers, and so on. More generally, the at least one data source may be any data storage within the environment, which includes file servers and any cloud-based data storage, such as those provided by Microsoft SharePoint, Google Drive, and so on.

An embedding is a representation of values or objects, like text, images or audio, that can be understood and processed by machine learning models. An embedding usually takes the form of a vector, and thus the terms “embedding” and “embedding vector” are used interchangeably herein. An embedding is therefore a mathematical representation of a data item (e.g. text, image, video, audio, etc.), and may represent some or all of the content of the data item. For example, an embedding may represent the semantic meaning of a data item. Embeddings make it possible for machine learning models to understand the relationships between different data items. Embeddings are normally analysed within embedding space, i.e. a mathematical space in which similar items are positioned closer to one another than less similar items. For example, if embedding A for data item A is close to embedding B for data item B in embedding space, then data item A and data item B are similar in some way. For example, data item A may be a personnel file for an employee within an organisation, while data item B may be a job application from a candidate for a job within the organisation. Since both data items contain personal information about people, they may both be considered similar. In contrast, embeddings A and B may be far away from embedding C for data item C. Data item C may be a finance report created by a finance team within the organisation. Data item C contains different information to data items A and B, so it considered to be dissimilar.

In some cases, the step of generating at least one embedding vector for the data item may comprise using an embedding model (i.e. a machine learning model). The embedding model may be part of the trained ML model used to generate the classification label(s) for the data item, or may be a separate model.

The step of generating at least one classification label for the data item using a trained machine learning, ML, model may comprise: determining a cluster from a plurality of pre-defined clusters of data items, wherein the data item is more similar to the data items in the determined cluster than other clusters. The pre-defined clusters of data items may be defined during the training of the ML model itself, as described below. Each pre-defined cluster of data items is associated with at least one classification label, e.g. “confidential”, “HR”, “finance”, “engineering”, “legal”, etc. It will be understood that a cluster may be associated with a single label or two or more labels. Thus, classifying a data item involves determining which of these existing clusters the data item best matches or belongs to.

Determining the cluster may comprise comparing the generated at least one embedding vector for the data item with the embedding vector(s) of each data item in each cluster, and then determining which cluster of data items the data item is most similar to. This may involve calculating a cosine similarity between the generated at least one embedding vector and each embedding vector of each data item in the pre-defined clusters. Cosine similarity is a measure of the similarity between two vectors, and is calculated by determining the cosine of the angle θ between the two vectors. When θ is close to 0°, cosine θ is close to 1, which means the vectors are similar; when θ is close to 90°, cosine θ is close to 0, which means the vectors are orthogonal; and when θ is close to 180°, cosine θ is close to −1 which means the vectors are opposite. The cosine similarity may be used to determine which of the embedding vectors for the clusters of data items is most similar to the generated at least one embedding vector. Additionally or alternatively, each of the embedding vector for the clusters of data items within a predefined threshold distance (e.g. having a cosine θ value in a certain range), may be considered similar to the generated embedding vector.

The step of determining a cluster may comprise: identifying a cluster from the plurality of pre-defined clusters using the generated at least one embedding vector; and comparing metadata of data items in the identified cluster to the obtained metadata. That is, the metadata may be used to perform a check that the determined cluster is the right cluster for the data item being classified. This ensures that both the semantic content of the data item and the metadata are used to determine the most appropriate cluster, and thereby determine the most appropriate label.

The step of determining a cluster may comprise: using the identified cluster when the obtained metadata is similar to the metadata of the data items in the identified cluster. That is, when the obtained metadata is similar to (within some threshold or tolerance) or the same as the metadata of the items in the identified cluster, then the identified cluster is considered to be the most appropriate cluster. Certain types of metadata may be more relevant/important, and so a higher weight or emphasis may be placed on these types of metadata when determining whether the metadata is similar. For example, more emphasis may be placed on the owner/creator/editor type of metadata, based on their role within the environment/organisation, and/or based on a known risk associated with a specific user or a specific role from a directory or other repository associated with the environment/organisation. For example, different roles may be associated with different risk levels. For instance, a CEO is likely to be creating and editing highly confidential documents and so if the obtained metadata shows the data item was created by the CEO, and the data items in the cluster also contain data items created by the CEO, then the metadata is similar and the correct cluster appears to have been identified. Similarly, more weight or emphasis may be placed on the user(s) who assigned the labels in the identified cluster (role and department), because it is likely that they have assigned labels correctly.

In this case, generating at least one classification label for the data item using a trained machine learning, ML, model may comprise: retrieving at least one classification label associated with the identified cluster. The plurality of clusters may be stored in storage, together with their associated classification label(s), and thus the at least one classification label may be retrieved from storage.

Alternatively, the step of determining a cluster may comprise: identifying an alternative cluster from the plurality of pre-defined clusters using the obtained metadata when the obtained metadata is dissimilar to the metadata of the data items in the identified cluster. That is, when the obtained metadata is not similar to the metadata of the items in the identified cluster, then the identified cluster is not considered to be the most appropriate cluster, and an alternative cluster may be identified. The step may be repeated until the most appropriate cluster has been determined.

In this case, generating at least one classification label for the data item using a trained machine learning, ML, model may comprise: retrieving at least one classification label associated with the identified alternative cluster. The plurality of clusters may be stored in storage, together with their associated classification label(s), and thus the at least one classification label may be retrieved from storage.

The step of determining a cluster may comprise using a clustering algorithm of the trained ML model. That is, the trained ML model may be, or may comprise, a clustering algorithm.

Using a clustering algorithm comprises using any one of: a data clustering algorithm, a k-means clustering algorithm, and a density-based spatial clustering algorithm. K-means clustering is the simplest and most commonly used clustering algorithm for high dimensional data. It partitions the data into K clusters, where each data point belongs to the cluster with the nearest mean. DBSCAN (Density-Based Spatial Clustering of Applications with Noise) is an algorithm that is based on the density of data points in a region. It groups together data points that are close to each other in the data space. Hierarchical clustering is an algorithm that creates a hierarchy of clusters by either a bottom-up or top-down approach. It is useful for understanding the structure of the data and can handle high dimensional data well. Spectral clustering is an algorithm uses the eigenvalues of a similarity matrix to reduce the dimensionality of the data before applying a clustering algorithm like k-means. Mean shift clustering is an algorithm that works by updating candidates for centroids to be the mean of the points within a given region. It is not sensitive to the initial placement of centroids. It will be understood that this is a non-exhaustive and non-limiting list of example clustering algorithms that could be used to perform the clustering.

In some cases, each label may be assigned to or associated with at least one data management policy that is appropriate for that class. In such cases, once the uncategorised data items have been categorised and labelled, the appropriate security policy or policies can be quickly retrieved and used. This allows data management policies to be applied to new data items immediately rather than periodically when done manually, which improves data security and confidentiality.

Generating a confidence level for each classification label comprises generating a confidence level that indicates how confident the trained ML model is that the data item belongs in the determined cluster. For example, the confidence level may be 0% or 0 if the ML model is very uncertain or very unconfident that the data item belongs in the determined cluster, or may be 100% or 1 if the ML model is very certain or very confident, and anywhere between 0% and 100% or between 0 and 1 for other levels of certainty/confidence. It will be understood that it is desirable for the confidence level to be closer to 100% or 1 than to 0% or 0.

Determining whether the generated at least one classification label has an associated confidence level that is greater than or equal to a pre-defined confidence level comprises comparing the associated confidence level with a pre-defined confidence level that is defined for the environment. In other words, the pre-defined confidence level may be specific to each environment in which the method is being performed, e.g. a workplace or organisation. This allows the method to be customised for each environment. For example, environments with strict policies on data management and data loss prevention (e.g. government organisations, military organisations, or organisations conducting highly sensitive research and development) may want a higher confidence level than those organisations where data management is less critical.

As noted above, the data item may be newly created or newly modified. When the data item is newly modified, applying the generated at least one classification label to the data item may comprise replacing any previous label applied to the data item with the generated at least one classification label. In this way, any conflicts between the old label(s) and new label(s) is avoided.

Alternatively, when the data item is newly modified, applying the generated at least one classification label to the data item may comprise applying the generated at least one classification label in addition to any previous label applied to the data item.

As noted above, when the classification label has a confidence level equal to or above the pre-defined confidence level, the classification label is applied to the data item. However, when the generated at least one classification label is determined to have an associated confidence level that is less than a pre-defined confidence level, the method may comprise: discarding the generated at least one classification label. That is, when the confidence level is too low, the generated label is discarded and not applied to the data item. The data item is not labelled or re-labelled at this time and instead the data item is processed again when the trained ML model has been updated (which may occur periodically).

In this case, the method may further comprise: receiving an updated version of the trained ML model; and repeating, for the data item, the steps of generating at least one classification label, determining, and applying using the updated version of the trained ML model.

Some general features of the method are now described.

The step of obtaining metadata for the data item may comprise obtaining any one or more of the following types of metadata: file name; file path; a user identifier for and/or role of an owner of the data item; a user identifier for and/or role of a creator of the data item; a user identifier for and/or role of an editor of the data item; a user identifier for and/or role of each user who accessed the data item; file size; file type; a risk level associated with an owner of the data item; a risk level associated with a creator of the data item; and a risk level associated with an editor of the data item. It will be understood that this is a non-exhaustive and non-limiting list of example types of metadata.

The step of obtaining a data item may comprise obtaining a data item that is any one of: an email, a document, a file, a text file, a folder, an image, a video, an audio file, a diagram, a geographical map, a medical image, a medical data file, a portable document format file, and any other specialised file type. It will be understood that this is a non-exhaustive and non-limiting list of example data item types.

In some cases, a single embedding vector may be generated for each data item. This may be possible when the data item is small or when the whole of the data item relates to a single topic such that one embedding vector is sufficiently representative of all the content and semantic meaning within the data item.

In other cases, the method may further comprise: prior to generating at least one embedding vector for the data item, dividing the data item into two or more segments; wherein generating the at least one embedding vector comprises generating an embedding vector for each of the two or more segments. That is, in cases where the data item is large, a single embedding vector generated for the data item may not be very representative of all the content and semantic meaning within the data item. Thus, it may be useful to divide the data item into smaller chunks or segments, such that the generated embedding vectors capture the semantic meaning of the segments. For example, an image may be divided into image patches or segments, a video may be divided into segments containing one or more frames, and an audio file may be divided into smaller audio segments. The segments may be overlapping. It will be understood that any suitable way of dividing the data item may be used.

Preferably, the method may further comprise: calculating an average embedding vector for the data item by averaging the embedding vectors generated for the two or more segments of the data item; wherein generating at least one classification label comprises processing the average embedding vector and obtained metadata using the trained ML model. In other words, the embedding vectors generated for the segments are averaged in some way to create a single average embedding vector for the whole data item.

Optionally, to prevent data skew, the method may comprise performing an anomaly detection step prior to performing the calculation of the average embedding vector. That is, the anomaly detection may determine whether any of the embedding vectors generated for the segments of the data item are very different to the others in value(s) or in terms of their location in embedding space. If any of the embedding vectors are different (i.e. are outliers), then they may skew the average embedding vector for the whole data item, and thereby cause the data item to be incorrectly classified. Thus, by identifying any outliers and discounting/discarding them when calculating the average embedding vector for a data item, the accuracy of the classification process may be improved. It will also be understood that any averaging technique, such as the mean, may be used to perform the averaging.

In some cases, the step of generating at least one embedding vector may comprise: extracting text content from the data item; and generating at least one embedding vector for the extracted text content. Thus, the embedding vector(s) may be generated based on textual information within the data item. If the data item is, for example, an image or video, text may be extracted from the image or frames of the video. Additionally or alternatively, for videos or audio files, a transcript of any speech contained within the video/audio file may be extracted. The text may be extracted using, for example, optical character recognition, speech-to-text, or any other suitable text extraction mechanism.

In cases where text content is extracted from the data item, the method may further comprise: prior to the generating, translating the extracted text into a pre-defined natural language. A natural language is any language used by humans, as opposed to, for example, computer programming languages. The pre-defined natural language may be a human language that is selected or determined in advance, and may be linked to the language used to train the embedding model. The translation may be required because an embedding model used to generate the embedding vector may have been trained using data items in one or more specific natural languages, such as English. The embedding model may not be able to process text in other languages, and therefore, the translation enables the embedding model to generate embedding vectors for data items that may contain other natural languages. Any suitable technique may be used to perform the translation. For example, the translation may be performed using machine translation techniques, which may utilise a large language model or other natural language processing mechanism.

The method may further comprise: prior to the generating, dividing the extracted text content into two or more segments; wherein generating the at least one embedding vector comprises generating an embedding vector for each of the two or more segments. That is, in cases where the extracted text is long, a single embedding vector generated for the extracted text may not be very representative of all the content and semantic meaning within the text. There are two main reasons to divide the extracted text into chunks. One is that the context window of many embedding models is limited. For example, for OpenAI, the context window is 8 k tokens (i.e. words), and for some open-source models, it can be as low as 512 tokens (words). So, it is necessary to reduce the amount of text that is fed into the embedding model to generate the embedding vector. Another reason is that reducing the number of tokens (words) and limiting those tokens to be within the same page or paragraph, improves the accuracy of the semantic extraction. This is because the semantic meaning is better determined for shorter text segments. To avoid a loss of context, the division may comprise dividing the text content into overlapping segments, to avoid loss of context between segments. Thus, it may be useful to divide the extracted text into smaller chunks or segments, such that the generated embedding vectors capture the semantic meaning of the segments. The extracted text may be divided into pages, paragraphs, or into segments of a certain number of words. It will be understood that any suitable way of dividing the text may be used. Dividing the extracted text content into segments is also known as “chunking”.

In some cases, generating at least one embedding vector comprises: generating text content for the data item; and generating at least one embedding vector for the generated text content. This may be useful for uncategorised data items that do not contain any text that can be extracted. The generated text content may be a description or summary of the non-text content of the data item. For example, if the data item is an image (e.g. photograph, frame of a video, medical image, graph, schematic diagram, flowchart, diagram, etc.), the generated text content may summarise the meaning and content of the image. A large language model, LLM, may be used to generate the text content, for example.

Additionally or alternatively, for data items that do not contain any text that can be extracted, the at least one embedding vector may be generated for the non-text content of the data item. That is, the embedding model may be a multi-modal embedding model able to process multiple types of input data, and generate an embedding vector representing some or all of the content of the data item. For example, the embedding model may be able to generate an embedding vector representing features of an image or audio file. Alternatively, different single-modality embedding models may be used to process different types of input data. For example, one embedding model may be used to process text, another to process images or video frames, another to process audio, and so on. With respect to images, an image embedding model may be used. Image embedding models may receive an image, extract features from that image, and generate an embedding vector to represent the extracted features. Non-limiting examples of image embedding models include VisualBERT and vit-base-beans. With respect to images, images may not be divided into segments, but instead, if the image is too large to be processed by the embedding model, the image may be downscaled before being input into the embedding model. Any suitable downscaling technique may be used.

The method may further comprise: retrieving at least one data management policy corresponding to the at least one classification label applied to the data item. That is, each label may be assigned to or associated with at least one data management policy that is appropriate for that class/category. In such cases, once a data item has been labelled, the appropriate security policy or policies can be quickly retrieved and used. This allows data management policies to be applied to data items immediately rather than periodically when done manually, which improves data security and confidentiality.

In cases where a labelled data item has multiple labels, retrieving at least one security policy for the labelled data item may comprise: retrieving a security policy corresponding to each label of the multiple classification labels applied to the data item; and determining which security policy or policies to apply to the labelled data item. For example, the data item may be an email, and “email” may be a label, but the content of the email may be confidential, and “confidential” may be a label. In this case, it is appropriate to apply two labels to the data item. In this case, two data management policies may be retrieved-one for “email”, and one for “confidential”. The “email” security policy may relate to data retention, i.e. how long the email needs to be retained within the environment. The “confidential” policy may dictate who within the environment is able to access, read and/or edit the data item, and who is prevented from doing so. In this case, both policies may be applied to the data item without any conflict. However, in cases where the data management policies conflict or contradict with each other, it may be necessary to determine which data management policy to use, or how to use all of the retrieved policies. In some cases, the strictest data management policy of the retrieved policies may be applied.

The method may further comprise: implementing the retrieved at least one data management policy for the data item. That is, the policy may be implemented as soon as it is retrieved (and any conflicts are resolved).

In a second approach of the present techniques, there is provided a system for autonomously classifying data items within an environment, the system comprising: a plurality of data sources within the environment; and at least one processor coupled to the plurality of data sources and configured for: obtaining, from one of the plurality of data sources within the environment, a data item that is newly created or newly modified; generating at least one embedding vector for the data item, wherein the at least one embedding vector represents content of the data item; obtaining metadata for the data item; generating at least one classification label for the data item together with an associated confidence level for each classification label, by processing the generated at least one embedding vector and obtained metadata using a trained machine learning, ML, model; determining whether the associated confidence level is greater than or equal to a pre-defined confidence level; and applying the generated at least one classification label to the data item when the generated at least one classification label has an associated confidence level that is greater than or equal to the pre-defined confidence level.

The features described above with respect to the first approach apply equally to the second approach and therefore, for the sake of conciseness, are not repeated.

The step of applying the generated at least one classification label may comprise storing the data item in the data source with the generated at least one classification label.

In a third approach of the present techniques, there is provided a computer-implemented method for training a machine learning, ML, model to autonomously classify uncategorised data items within an environment, the method comprising: obtaining a training dataset comprising a plurality of labelled data items from data sources within the environment, and metadata for each labelled data item; generating at least one embedding vector for each labelled data item, wherein the at least one embedding vector represents content of the data item; and training the ML model to: cluster the plurality of labelled data items into a plurality of clusters, using the at least one embedding vector of each labelled data item and metadata for each labelled data item, wherein each cluster contains a subset of the plurality of labelled data items that are more similar to each other than to the labelled data items in other clusters.

Generally speaking, the labels of the labelled data items are used as the main ground truths to train the ML model to perform the clustering. However, the metadata is also used as another ground truth. This is because data items that are semantically different (i.e. have different content) may nevertheless have the same ground truth labels. If only the semantic content is used to perform the clustering, then the clustering would result in some data items being missed from the clusters (and therefore, not having the same labels applied to them). For example:
Some of the labelled data items in the training dataset may be from an HR department and may contain employee information (e.g. CVs, cover letters, job applications, contracts, and appraisal documents). These all have similar content, i.e. employee personal information. They have all been labelled “confidential” by the HR department.
Some of the labelled data items in the training dataset may be from a Finance department, and may contain sensitive financial data (e.g. company accounts). These all have similar content. They have all been labelled “confidential” by the Finance Department.

If only the semantic content, i.e. the embedding vectors, were used to perform the clustering, then two separate clusters would be generated for the confidential HR data items and for the confidential Finance data items, even though the ground truth labels for all the data items is the same (i.e. “confidential”). Thus, the present techniques use both the semantic content and the metadata to perform the clustering, to avoid this sort of problem.

To achieve this, the ML model may perform the clustering by considering, together, the at least one embedding vector for each labelled data item and the metadata for that data item. That is, pairs of data—the label(s) and metadata for each data item in the training dataset —may be processed by the ML model during the training.

Alternatively, the method may comprise augmenting the generated embedding vectors with the metadata, so that the embedding vectors themselves contain the metadata information. For example, the metadata for a data item may be concatenated with the embedding vector(s) of the data item. In this way, the ML model processes the augmented embedding vectors.

The labelled data items may be labelled by individuals within the environment, e.g. the organisation. The labels for the data items are considered to be the ground truths for the purpose of training, and the ML model is being trained to arrive at the same labels. Thus, training the ML model to cluster the plurality of labelled data items may comprise: comparing, for each cluster, labels of each labelled data item in the cluster to determine whether the labels of each labelled data item in the cluster is the same; and training the ML model to generate clusters containing labelled data items with the same labels.

Any suitable technique may be used to train the ML model, such as, for example, supervised learning, semi-supervised learning and unsupervised learning.

The step of generating at least one embedding vector may comprise using an embedding model (i.e. a machine learning model). The embedding model may be part of the ML model that is being trained to generate the classification label(s) for the data item, or may be a separate model.

Training the ML model to cluster the plurality of labelled data items into a plurality of clusters may comprise clustering the labelled data items in embedding space. Embedding vectors which are clustered together in embedding space represent data items which are similar to each other. This clustering is based on both their semantic content and their metadata.

The step of clustering the plurality of data items may comprise using any one of: a data clustering algorithm, a k-means clustering algorithm, and a density-based spatial clustering algorithm. K-means clustering is the simplest and most commonly used clustering algorithm for high dimensional data. It partitions the data into K clusters, where each data point belongs to the cluster with the nearest mean. DBSCAN (Density-Based Spatial Clustering of Applications with Noise) is an algorithm that is based on the density of data points in a region. It groups together data points that are close to each other in the data space. Hierarchical clustering is an algorithm that creates a hierarchy of clusters by either a bottom-up or top-down approach. It is useful for understanding the structure of the data and can handle high dimensional data well. Spectral clustering is an algorithm uses the eigenvalues of a similarity matrix to reduce the dimensionality of the data before applying a clustering algorithm like k-means. Mean shift clustering is an algorithm that works by updating candidates for centroids to be the mean of the points within a given region. It is not sensitive to the initial placement of centroids. It will be understood that this is a non-exhaustive and non-limiting list of example clustering algorithms that could be used to perform the clustering.

Once clustered, at least one label is applied to each cluster. This may be based on the labels of the data items in those clusters, or may be generated in a different way.

As noted above, at least one classification label may be generated for each cluster, where the label is/labels are specific to the content of the data items in the cluster. The word “specific” means that the label is descriptive of the content type or data type of the data items in the cluster. In some cases, a single classification label may be generated for each cluster. In other cases, two or more classification labels may be generated for each cluster, where each label is specific to the content. This may occur when there are multiple possible, and equally valid, labels for content. For example, the labels “marketing” and “business development” may be generated for a cluster in which all the data items are related to activities concerning business development and marketing. Thus, sometimes the multiple labels may be synonyms. In this case, it may be desirable to select one of the labels to use. In another example, the labels may not be synonyms. For example, the labels “invoices” and “tax” may be generated for data items in a cluster that are related to invoice queries or tax queries, or invoices that include a tax breakdown. Similarly, the labels “photographs” and “people” may be generated for data items that are photographs that contain people. In these cases, both labels may be equally applicable. Alternatively, the generation of two or more labels which are not synonyms may indicate the clustering needs to be redone as the data items are not similar enough.

The method may further comprise: storing, in a database, the generated embedding vectors, associated cluster, and classification label. That is, once the clusters have been determined, some or all of the generated embedding vectors for the data items in each cluster may be added to a database. The embedding vectors added to the database may be added in addition to the associated cluster and classification label. These clusters become the pre-defined clusters used by the trained ML model to perform the classification and labelling, described above. Storing some or all of the embedding vectors for each cluster makes it easier for the right cluster to be determined for new data items, because a comparison of embedding vectors can be performed, as described above.

In a fourth approach of the present techniques, there is provided a computer-implemented method for controlling actions performed with respect to a data item, the method comprising: obtaining, from a data source within the environment, a data item that is newly created or newly modified; generating at least one embedding vector for the data item, wherein the at least one embedding vector represents content of the data item; obtaining metadata for the data item; generating at least one classification label for the data item together with an associated confidence level for each classification label, by processing the generated at least one embedding vector and obtained metadata using a trained machine learning, ML, model; determining whether the associated confidence level is greater than or equal to a pre-defined confidence level; applying the generated at least one classification label to the data item when the generated at least one classification label has an associated confidence level that is greater than or equal to the pre-defined confidence level; and controlling an action performed with respect to the data item based on the applied generated at least one classification label.

Advantageously, the present techniques enable actions to be automatically and immediately applied to, or with respect to, a data item once it has been labelled and at least one appropriate data management policy has been identified.

The features described above with respect to the first approach apply equally to the fourth approach and therefore, for the sake of conciseness, are not repeated.

The applying step may comprise applying multiple classification labels to each data item, for the same reasons as those described above. In this case, retrieving at least one data management policy for the labelled data item may comprise: retrieving a data management policy corresponding to each classification label of the multiple classification labels applied to the data item; and determining which data management policy or policies to use to control actions performed with respect to the labelled data item.

In some cases, where the retrieved policies do not conflict or contradict with each other, the determining may comprise determining that all of the retrieved policies can be used. For example, one of the retrieved policies may relate to data retention and one may relate to access, and both of these policies can be applied. In cases where the retrieved policies conflict or contradict each other, determining which data management policy or policies to use to control actions performed with respect to the labelled data item may comprise: selecting the most strict data management policy from the data management policies corresponding to the multiple labels. The strictness of a policy may depend on what the policy relates to. For example, if a policy allows access for one classification, but denies another, then “deny” could be the resultant action. For data retention, if one classification requires data to be kept for 1 year, and another classification for 2 years, the longest retention period will be chosen. If one classification allows access without producing an audit record and another allows access but requires audit record, then an audit record should be produced.

The method may further comprise: receiving an override instruction to ignore one or more of: a label applied to the labelled data item, and a data management policy associated with a label applied to the labelled data item. Thus, an administrator of the system may be able to override a data management policy associated with a labelled data item.

Using the at least one data management policy to control an action performed with respect to the labelled data item may comprise: receiving a request to perform an action with respect to the labelled data item; determining, using the at least one data management policy, whether the request should be granted; and granting the request to perform the action with respect to the labelled data item responsive to the determining. For example, a user of the system may attempt to delete a labelled data item. The data management policy(ies) associated with the labelled data item may determine whether the labelled data item can be deleted. For example, a data management policy may specify that the labelled data item has to be retained within the system for a period of five years. If the labelled data item has existed in the system for less than five years, the request to delete the labelled data item will not be granted in view of the data management policy. In another example, a user of the system may attempt to read a labelled data item which is associated with a data management policy that restricts access to specific users. The user's request may only be granted if they are listed as a user that is permitted access.

Using the at least one data management policy to control an action performed with respect to the labelled data item may comprise controlling any one or more of: accessing, reading, modifying, editing, sharing, archiving, deleting, distributing within the environment, and distributing external to the environment. It will be understood that this is a non-exhaustive list of example actions that could be performed with respect to a labelled data item. The action may be performed by a separate access management system.

Controlling an action performed with respect to the data item may comprise: retrieving, using each applied classification label, at least one data management policy from a stored plurality of data management policies; and controlling an action performed with respect to the data item using the retrieved at least one data management policy. That is, as explained above, one or more data management policies may be linked to each classification label, such that once a data item has been labelled, the policies linked to the label can be applied automatically and immediately.

In one example, the retrieved at least one data management policy may specify a location where data items having the applied classification label are to be stored; and controlling an action performed with respect to the data item may comprise storing the data item in the location specified by the retrieved data management policy. For example, data items may be stored in particular locations/drives/databases depending on how often they are likely to be accessed or on their security profile/confidentiality level, both of which may be linked to the label applied to the data item. For example, data items A labelled with certain labels X may not need to be accessed as often as other data items B with other labels Y, and so data items A may be stored in cloud storage (according to the policy linked to the label X), while data items B may be stored in on-premises storage (according to the policy linked to the label Y). Similarly, data items labelled with a “confidential” label or “high security” label may be stored in a location that is password protected or otherwise access controlled, while other data items may be stored in a location that can be accessed freely.

In another example, the retrieved at least one data management policy may specify a security type to be applied to data items having the applied classification label; and controlling an action performed with respect to the data item may comprise applying the specified security type to the data item. For example, the security type may be any one or more of: encryption; key management; and outputting real-time alerts whenever the data item is accessed (and/or read, edited, modified, shared, archived, deleted, distributed within the environment, and distributed external to the environment).

In another example, the retrieved at least one data management policy may specify that data items having the applied classification label cannot be transmitted outside of the environment; and controlling an action performed with respect to the data item may comprise blocking the transmission of the data item outside of the environment. Thus, when a user attempts to send a data item outside of the environment, the email server may block the transmission by seeing the label of the data item and implementing the associated data management policy. The user may be alerted or notified when the transmission is blocked. Other individuals (e.g. an administrator) may also be notified when someone attempts to transmit (e.g. email) a data item which cannot be transmitted outside of the environment.

In another example, the retrieved at least one data management policy may specify that data items having the applied classification label must be edited before transmission outside of the environment; and controlling an action performed with respect to the data item may comprise editing the data item prior to transmission of the data item outside of the environment. For example, the editing may comprise automatically redacting certain information or content within the data item.

In a fifth approach of the present techniques, there is provided a system for controlling actions performed with respect to a data item within an environment, the system comprising: a plurality of data sources within the environment; and at least one processor coupled to the plurality of data sources and configured for: obtaining, from one of the plurality of data sources within the environment, a data item that is newly created or newly modified; generating at least one embedding vector for the data item, wherein the at least one embedding vector represents content of the data item; obtaining metadata for the data item; generating at least one classification label for the data item together with an associated confidence level for each classification label, by processing the generated at least one embedding vector and obtained metadata using a trained machine learning, ML, model; determining whether the associated confidence level is greater than or equal to a pre-defined confidence level; applying the generated at least one classification label to the data item when the generated at least one classification label has an associated confidence level that is greater than or equal to the pre-defined confidence level; and controlling an action performed with respect to the data item based on the applied generated at least one classification label.

The features described above with respect to the first approach and fourth approach apply equally to the fifth approach and therefore, for the sake of conciseness, are not repeated.

The system may further comprise: storage storing a plurality of data management policies; and wherein controlling an action performed with respect to the data item comprises: retrieving, using each applied classification label, at least one data management policy from the stored plurality of data management policies; and controlling an action performed with respect to the data item using the retrieved at least one data management policy.

The retrieved at least one data management policy may specify a location where data items having the applied classification label are to be stored; and controlling an action performed with respect to the data item may comprise storing the data item in the location specified by the retrieved data management policy. The location may be one of: an on-premises storage or a cloud or remote storage.

The retrieved at least one data management policy may specify a security type to be applied to data items having the applied classification label; and controlling an action performed with respect to the data item may comprise applying the specified security type to the data item. The security type may be any one or more of: encryption; key management; and outputting real-time alerts whenever the data item is accessed.

The retrieved at least one data management policy may specify that data items having the applied classification label cannot be transmitted outside of the environment; and controlling an action performed with respect to the data item may comprise blocking the transmission of the data item outside of the environment.

The retrieved at least one data management policy may specify that data items having the applied classification label must be edited before transmission outside of the environment; and controlling an action performed with respect to the data item may comprise editing the data item prior to transmission of the data item outside of the environment.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD-or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

### BRIEF DESCRIPTION OF THE DRAWINGS

Implementations of the present techniques will now be described, by way of example only, with reference to the accompanying drawings, in which:

FIG. 1 is a flowchart of example steps for autonomously classifying data items within an environment;

FIG. 2 is a flowchart of example steps to generate the classification label;

FIG. 3 is a flowchart of example steps to train a machine learning, ML, model to autonomously classify data items within an environment;

FIG. 4 is a flowchart of example steps to control actions with respect to labelled data items; and

FIG. 5 is a block diagram of a system for autonomously classifying data items within an environment.

### DETAILED DESCRIPTION OF THE DRAWINGS

Broadly speaking, the present techniques provide an automatic way of classifying data items within an environment (e.g. a business, workplace, organisation, etc.). This is advantageous over existing techniques which require manual classification of data items, which is time consuming in environments where hundreds of new data items may be generated or modified in a day or week. The present techniques use the content of a data item together with metadata associated with the data item to classify the data item, and thereby label the data item.

Manually categorizing company documents is a challenging and often impractical task due to several factors:
Volume: Companies generate vast amounts of data. From emails, reports, invoices, to contracts and technical documents, the sheer number of documents can be overwhelming. Manually reviewing each document for categorization is time-consuming and labour-intensive
Variety: Documents within an organization can be highly diverse, ranging across different formats (text, PDF, images, spreadsheets), languages, and subject matter. Understanding and accurately categorizing such a wide array of documents requires specialized knowledge and expertise, which may not be feasible to have in one individual or even a team.
Complexity: Many documents contain nuanced information that can be interpreted in various ways. Determining the appropriate category for such documents can be subjective and may require context that is not immediately apparent, leading to inconsistencies in categorization.
Human Error: Manual categorization is prone to errors due to fatigue, misinterpretation, or oversight. Consistency in categorization is hard to maintain over large datasets when multiple individuals are involved, each with their own understanding and interpretations.
Maintainability: As new documents are continuously created, keeping the categorization up-to-date manually becomes an ongoing challenge. Additionally, the categorization system may need to evolve as business needs change, requiring constant attention and revision.

For at least these reasons, an automated categorization solution is required.

As mentioned above, existing document classification systems using rules or regular expressions. Data loss prevention, DLP, systems use classification labels to monitor sensitive data, block suspicious operations within an organisation/environment, and enforce data access policies. Other techniques perform document classification according to a given learning set and categories. In contrast, the present techniques advantageously provide an autonomous process for category discovery with zero friction caused to the user or system administrator.

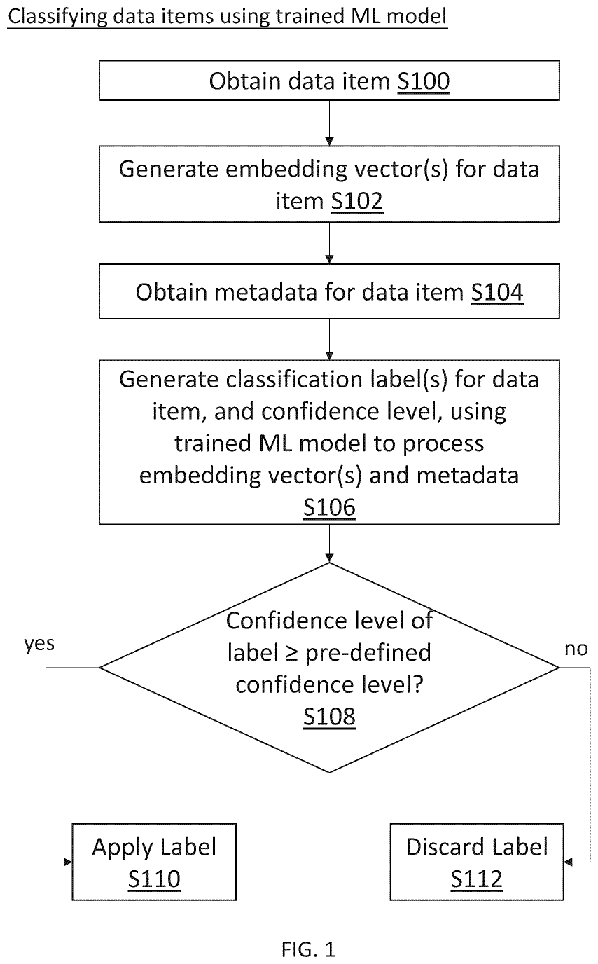

FIG. 1 is a flowchart of example steps for autonomously classifying data items within an environment. The method comprises: obtaining, from a data source within the environment, a data item that is newly created or newly modified (step S100); generating at least one embedding vector for the data item, wherein the at least one embedding vector represents content of the data item (step S102); obtaining metadata for the data item (step S104); generating at least one classification label for the data item together with an associated confidence level for each classification label, by processing the generated at least one embedding vector and obtained metadata using a trained machine learning, ML, model (step S106); determining whether the associated confidence level is greater than or equal to a pre-defined confidence level (step S108); and applying the generated at least one classification label to the data item when the generated at least one classification label has an associated confidence level that is greater than or equal to a pre-defined confidence level (step S110).

The method may be performed either whenever a newly modified or newly created data item is identified within the data sources, or whenever a minimum number of newly modified and/or newly created data items are identified within the data sources (for efficiency), or periodically (e.g. every x minutes, every hour, every 12 hours, every day, every week, etc.) The frequency may be defined for the environment, i.e. may be specific to each environment.

At step S100, the data items are obtained from at least one data source within the environment. The or each data source may be any computing device within the environment. Examples of computing devices include laptops, desktop computers, smartphones, servers, and so on. More generally, the at least one data source may be any data storage within the environment, which includes file servers and any cloud-based data storage, such as those provided by Microsoft SharePoint, Google Drive, and so on.

In some cases, the step (S102) of generating at least one embedding vector for the data item may comprise using an embedding model (i.e. a machine learning model). The embedding model may be part of the trained ML model used to generate the classification label(s) for the data item, or may be a separate model.

The step (S104) of obtaining metadata may comprise obtaining, for example, an individual who owns the data item, created the data item, and/or edited the data item. Their role or known risk may also be obtained, from a directory associated with the environment or other source.

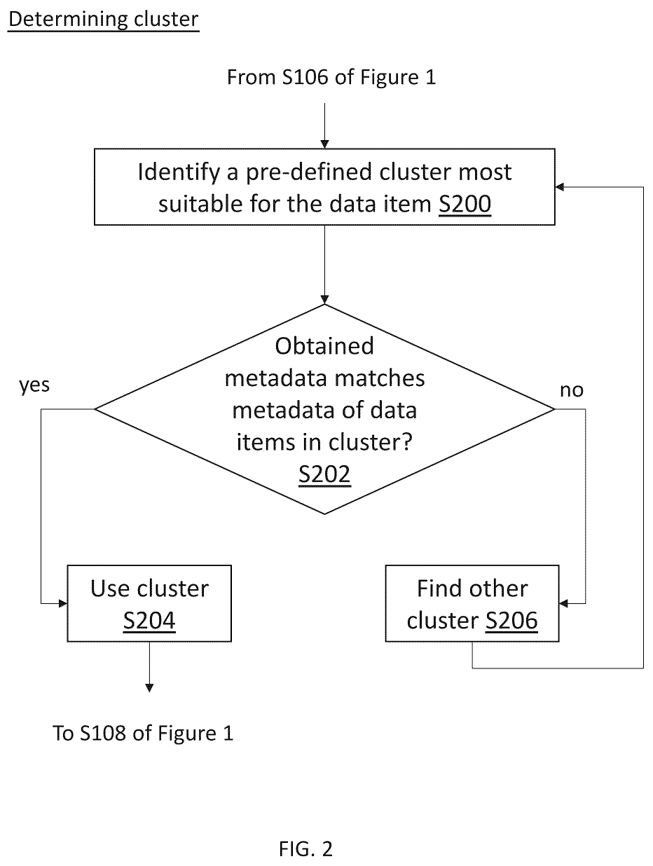

FIG. 2 is a flowchart of example steps to generate the classification label.

In FIG. 1, the step (S106) of generating at least one classification label for the data item using a trained machine learning, ML, model may comprise: determining a cluster from a plurality of pre-defined clusters of data items, wherein the data item is more similar to the data items in the determined cluster than other clusters. Thus, as shown in FIG. 2, step S106 may involve determining the most suitable pre-defined cluster for the data item (step S200). The pre-defined clusters of data items may be defined during the training of the ML model itself, as described below. Each pre-defined cluster of data items is associated with at least one classification label, e.g. “confidential”, “HR”, “finance”, “engineering”, “legal”, etc. It will be understood that a cluster may be associated with a single label or two or more labels. Thus, classifying a data item involves determining which of these existing clusters the data item best matches or belongs to.

Determining the cluster (step S200) may comprise comparing the generated at least one embedding vector for the data item with the embedding vector(s) of each data item in each cluster, and then determining which cluster of data items the data item is most similar to. This may involve calculating a cosine similarity between the generated at least one embedding vector and each embedding vector of each data item in the pre-defined clusters. Cosine similarity is a measure of the similarity between two vectors, and is calculated by determining the cosine of the angle θ between the two vectors. When θ is close to 0°, cosine θ is close to 1, which means the vectors are similar; when θ is close to 90°, cosine θ is close to 0, which means the vectors are orthogonal; and when θ is close to 180°, cosine θ is close to −1 which means the vectors are opposite. The cosine similarity may be used to determine which of the embedding vectors for the clusters of data items is most similar to the generated at least one embedding vector. Additionally or alternatively, each of the embedding vector for the clusters of data items within a predefined threshold distance (e.g. having a cosine θ value in a certain range), may be considered similar to the generated embedding vector.

The step (S200) of determining a cluster may comprise: identifying a cluster from the plurality of pre-defined clusters using the generated at least one embedding vector; and comparing metadata of data items in the identified cluster to the obtained metadata (step S202). That is, the metadata may be used to perform a check that the determined cluster is the right cluster for the data item being classified. This ensures that both the semantic content of the data item and the metadata are used to identify the most appropriate cluster, and thereby determine the most appropriate label.

The step of determining a cluster may comprise: using the identified cluster as the determined cluster when the obtained metadata is similar to the metadata of the data items in the identified cluster (step S204). That is, when the obtained metadata is similar to the metadata of the items in the determined cluster, then the determined cluster is considered to be the most appropriate cluster. The process then returns to step S108 of FIG. 1.

In this case, generating at least one classification label for the data item using a trained machine learning, ML, model may comprise: retrieving at least one classification label associated with the identified cluster.

Alternatively, the step of determining a cluster may comprise: identifying an alternative cluster from the plurality of pre-defined clusters using the obtained metadata (step S206) when the obtained metadata is dissimilar to the metadata of the data items in the identified cluster. That is, when the obtained metadata is not similar to the metadata of the items in the identified cluster, then the identified cluster is not considered to be the most appropriate cluster, and an alternative cluster may be identified. The step may be repeated until the most appropriate cluster has been identified, as shown by the arrow between steps S206 and S200.

In this case, generating at least one classification label for the data item using a trained machine learning, ML, model may comprise: retrieving at least one classification label associated with the identified alternative cluster.

The step of determining a cluster may comprise using a clustering algorithm of the trained ML model. That is, the trained ML model may be, or may comprise, a clustering algorithm.

Using a clustering algorithm comprises using any one of: a data clustering algorithm, a k-means clustering algorithm, and a density-based spatial clustering algorithm. K-means clustering is the simplest and most commonly used clustering algorithm for high dimensional data. It partitions the data into K clusters, where each data point belongs to the cluster with the nearest mean. DBSCAN (Density-Based Spatial Clustering of Applications with Noise) is an algorithm that is based on the density of data points in a region. It groups together data points that are close to each other in the data space. Hierarchical clustering is an algorithm that creates a hierarchy of clusters by either a bottom-up or top-down approach. It is useful for understanding the structure of the data and can handle high dimensional data well. Spectral clustering is an algorithm uses the eigenvalues of a similarity matrix to reduce the dimensionality of the data before applying a clustering algorithm like k-means. Mean shift clustering is an algorithm that works by updating candidates for centroids to be the mean of the points within a given region. It is not sensitive to the initial placement of centroids. It will be understood that this is a non-exhaustive and non-limiting list of example clustering algorithms that could be used to perform the clustering.

In some cases, each label may be assigned to or associated with at least one data management policy that is appropriate for that class. In such cases, once the uncategorised data items have been categorised and labelled, the appropriate security policy or policies can be quickly retrieved and used. This allows data management policies to be applied to new data items immediately rather than periodically when done manually, which improves data security and confidentiality.

Returning to FIG. 1, at step S106, the method comprises generating a confidence level for each classification label for the data item, which indicates how confident the trained ML model is that the data item belongs in the determined cluster. For example, the confidence level may be 0% or 0 if the ML model is very uncertain or very unconfident that the data item belongs in the determined cluster, or may be 100% or 1 if the ML model is very certain or very confident, and anywhere between 0% and 100% or between 0 and 1 for other levels of certainty/confidence. It will be understood that it is desirable for the confidence level to be closer to 100% or 1 than to 0% or 0.

Determining, at step S108, whether the generated at least one classification label has an associated confidence level that is greater than or equal to a pre-defined confidence level comprises comparing the associated confidence level with a pre-defined confidence level that is defined for the environment. In other words, the pre-defined confidence level may be specific to each environment in which the method is being performed, e.g. a workplace or organisation. This allows the method to be customised for each environment. For example, environments with strict policies on data management and data loss prevention (e.g. government organisations, military organisations, or organisations conducting highly sensitive research and development) may want a higher confidence level than those organisations where data management is less critical.

As noted above, the data item may be newly created or newly modified. When the data item is newly modified, applying (step S110) the generated at least one classification label to the data item may comprise replacing any previous label applied to the data item with the generated at least one classification label. In this way, any conflicts between the old label(s) and new label(s) is avoided.

Alternatively, when the data item is newly modified, applying the generated at least one classification label to the data item may comprise applying (step S110) the generated at least one classification label in addition to any previous label applied to the data item.

As noted above, when the classification label has a confidence level equal to or above the pre-defined confidence level, the classification label is applied to the data item. However, when the generated at least one classification label is determined (at step S108) to have an associated confidence level that is less than a pre-defined confidence level, the method may comprise: discarding the generated at least one classification label (step S112). That is, when the confidence level is too low, the generated label is discarded and not applied to the data item. The data item is not labelled or re-labelled at this time and instead the data item is processed again when the trained ML model has been updated (which may occur periodically).

In this case, the method may further comprise: receiving an updated version of the trained ML model; and repeating, for the data item, the steps of generating at least one classification label, determining, and applying using the updated version of the trained ML model.

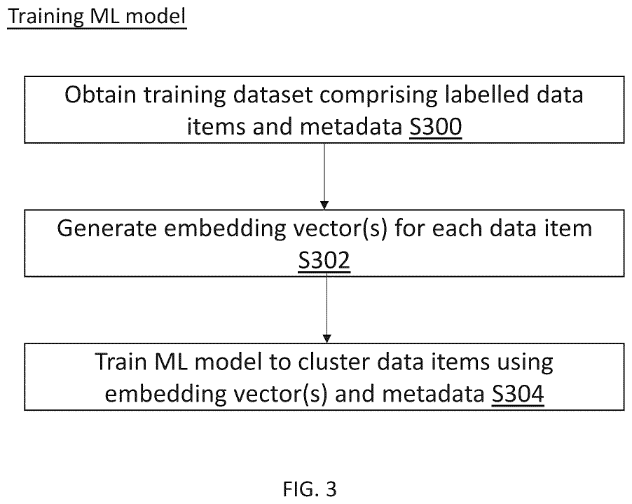

FIG. 3 is a flowchart of example steps to train a machine learning, ML, model to autonomously classify data items within an environment. The method comprises: obtaining a training dataset comprising a plurality of labelled data items from data sources within the environment, and metadata for each labelled data item (step S300); generating at least one embedding vector for each labelled data item, wherein the at least one embedding vector represents content of the data item (step S302); and training the ML model to: cluster the plurality of labelled data items into a plurality of clusters, using the at least one embedding vector of each labelled data item and metadata for each labelled data item, wherein each cluster contains a subset of the plurality of labelled data items that are more similar to each other than to the labelled data items in other clusters (step S304).

The labelled data items may be labelled by individuals within the environment, e.g. the organisation. The labels for the data items are considered to be the ground truths for the purpose of training, and the ML model is being trained to arrive at the same labels. Thus, training (step S304) the ML model to cluster the plurality of labelled data items may comprise: comparing, for each cluster, labels of each labelled data item in the cluster to determine whether the labels of each labelled data item in the cluster is the same; and training the ML model to generate clusters containing labelled data items with the same labels.

The training process may also comprise a verification or validation step, using other labelled data items, to check that the training has occurred well. Any standard technique may be used for the validation. Some of the data items in the training data set may be set aside for the validation step (and therefore, not used for the training).

The metadata associated with each data item may comprise, for example, the name of an individual who owns the data item, created the data item, and/or edited the data item. The metadata may also comprise their role or known risk/security level. The metadata may include the name of an individual who assigned the label to the data item, and/or their role, department or risk/security level.

Any suitable technique may be used to train the ML model.

It will be understood that validation of the model may also be performed. Training of the ML model may involve using one part of the training dataset and validation may be performed using another part of the training dataset. Validation may be performed to ensure that the training dataset is sufficiently large to perform meaningful training, and to ensure that labelled data items are diverse in nature and not e.g. all of the same type or labelled using the same label. If the validation fails, a system administrator will be alerted and requested to correct the issues, e.g. by providing more labelled data items.

The step (S302) of generating at least one embedding vector may comprise using an embedding model (i.e. a machine learning model). The embedding model may be part of the ML model that is being trained to generate the classification label(s) for the data item, or may be a separate model.

Training the ML model (step S304) to cluster the plurality of labelled data items into a plurality of clusters may comprise clustering the labelled data items in embedding space. Embedding vectors which are clustered together in embedding space represent data items which are similar to each other. This clustering is based on both their semantic content and their metadata.

The step of clustering the plurality of data items may comprise using any one of: a data clustering algorithm, a k-means clustering algorithm, and a density-based spatial clustering algorithm. K-means clustering is the simplest and most commonly used clustering algorithm for high dimensional data. It partitions the data into K clusters, where each data point belongs to the cluster with the nearest mean. DBSCAN (Density-Based Spatial Clustering of Applications with Noise) is an algorithm that is based on the density of data points in a region. It groups together data points that are close to each other in the data space. Hierarchical clustering is an algorithm that creates a hierarchy of clusters by either a bottom-up or top-down approach. It is useful for understanding the structure of the data and can handle high dimensional data well. Spectral clustering is an algorithm uses the eigenvalues of a similarity matrix to reduce the dimensionality of the data before applying a clustering algorithm like k-means. Mean shift clustering is an algorithm that works by updating candidates for centroids to be the mean of the points within a given region. It is not sensitive to the initial placement of centroids. It will be understood that this is a non-exhaustive and non-limiting list of example clustering algorithms that could be used to perform the clustering.

Once clustered, at least one label is applied to each cluster. This may be based on the labels of the data items in those clusters, or may be generated in a different way.

As noted above, at least one classification label may be generated for each cluster, where the label is/labels are specific to the content of the data items in the cluster. The word “specific” means that the label is descriptive of the content type or data type of the data items in the cluster. In some cases, a single classification label may be generated for each cluster. In other cases, two or more classification labels may be generated for each cluster, where each label is specific to the content. This may occur when there are multiple possible, and equally valid, labels for content. For example, the labels “marketing” and “business development” may be generated for a cluster in which all the data items are related to activities concerning business development and marketing. Thus, sometimes the multiple labels may be synonyms. In this case, it may be desirable to select one of the labels to use. In another example, the labels may not be synonyms. For example, the labels “invoices” and “tax” may be generated for data items in a cluster that are related to invoice queries or tax queries, or invoices that include a tax breakdown. Similarly, the labels “photographs” and “people” may be generated for data items that are photographs that contain people. In these cases, both labels may be equally applicable. Alternatively, the generation of two or more labels which are not synonyms may indicate the clustering needs to be redone as the data items are not similar enough.

The method may further comprise (not shown in FIG. 3): storing, in a database, the generated embedding vectors, associated cluster, and classification label. That is, once the clusters have been determined, some or all of the generated embedding vectors for the data items in each cluster may be added to a database. The embedding vectors added to the database may be added in addition to the associated cluster and classification label. These clusters become the pre-defined clusters used by the trained ML model to perform the classification and labelling, described above. Storing some or all of the embedding vectors for each cluster makes it easier for the right cluster to be determined for new data items, because a comparison of embedding vectors can be performed, as described above.

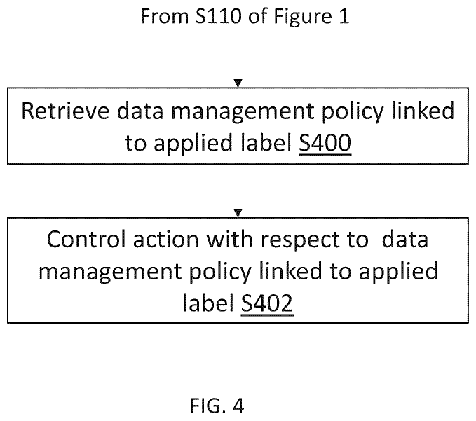

FIG. 4 is a flowchart of example steps to control actions with respect to labelled data items. The method for controlling actions performed with respect to a data item comprises the steps shown in FIG. 1 and described above. Thus, after a label has been applied to an unlabelled data item, the method to control actions comprises: controlling an action performed with respect to the data item based on the applied generated at least one classification label.

Controlling an action performed with respect to the data item may comprise: retrieving, using each applied classification label, at least one data management policy from a stored plurality of data management policies (step S400); and controlling an action performed with respect to the data item using the retrieved at least one data management policy (step S402). That is, as explained above, one or more data management policies may be linked to each classification label, such that once a data item has been labelled, the policies linked to the label can be applied automatically and immediately.

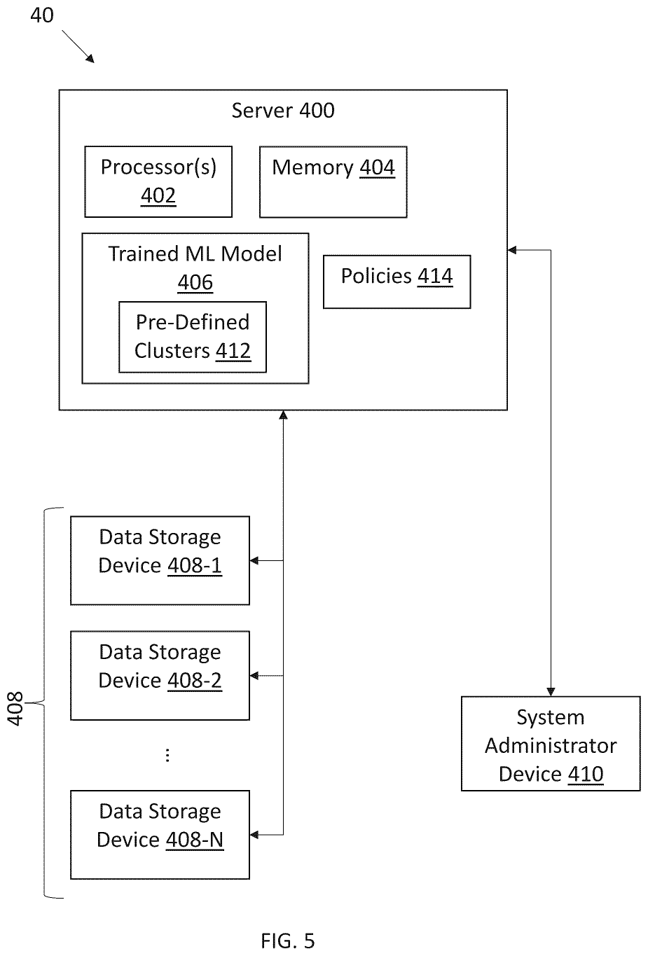

FIG. 5 is a block diagram of a system 40 for autonomously classifying data items within an environment, such as within a business, workplace, organisation, department within an organisation, etc. The system 40 comprises a plurality of data sources or data storage devices 408, such as data sources 408-1, 408-2 to 408-N within the environment. The or each data source 408 may be any computing device within the environment. Examples of computing devices include laptops, desktop computers, smartphones, servers, and so on. More generally, the at least one data source may be any data storage within the environment, which includes file servers and any cloud-based data storage, such as those provided by Microsoft SharePoint, Google Drive, and so on.

The system 40 also comprises at least one server 400, which is able to run the method to classify data items. As the system 40 comprises a plurality of data sources, the system 40 may also comprise a plurality of servers or a single server able to process data from all of the data sources. The number of servers may be equal to, or may not be equal to, the number of data sources in the system 40. In one example, multiple data sources may be linked to a server. For example, the environment may be a law firm, and the law firm may have a number of departments, such as accounting, HR, marketing, and legal, and each department may contain a plurality of data sources, and each department's data sources may be connected to a single server.

The server 400 may comprise at least one processor 402 coupled to memory 404. Thus, each processor is coupled to at least one of the plurality of data sources. The processor is configured to obtain newly added or newly modified data items from the data source(s), and perform steps to classify the obtained data items.

The at least one processor 402 may perform the following steps (as shown in FIG. 1): obtaining, from one of the plurality of data sources 408 within the environment, a data item that is newly created or newly modified; generating at least one embedding vector for the data item, wherein the at least one embedding vector represents content of the data item; obtaining metadata for the data item; generating at least one classification label for the data item, together with an associated confidence level for each classification label, by processing the generated at least one embedding vector and obtained metadata using a trained machine learning, ML, model 406 having pre-defined clusters 412; determining whether the associated confidence level is greater than or equal to a pre-defined confidence level; and applying the generated at least one classification label to the data item when the generated at least one classification label has an associated confidence level that is greater than or equal to the pre-defined confidence level.

The processor(s) 402 may store the data item in the data source 408 (i.e. the same data source form where it was obtained) with the generated at least one classification label.

The system comprises a plurality of data management policies 414. In some cases, each generated label may be assigned to or associated with at least one data management policy 414 that is appropriate for that class. In such cases, once the data items have been categorised and labelled, the appropriate security policy or policies 414 can be quickly retrieved and used. This allows data management policies to be applied to new data items immediately rather than periodically when done manually, which improves data security and confidentiality.

An administrator of the system, via a system administrator device 410, may be able to override a data management policy associated with a labelled data item.

The administrator may also be able to query an labels applied to a data item, as well as query the data items used to generate the pre-defined clusters (during the training). Thus, the present techniques also allow for explainability.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method for autonomously classifying data items within an environment, the method comprising:
obtaining, from a data source within the environment, a data item that is newly created or newly modified;
generating at least one embedding vector for the data item, wherein the at least one embedding vector represents content of the data item;
obtaining metadata for the data item;
generating at least one classification label for the data item together with an associated confidence level for each classification label, by processing the generated at least one embedding vector and obtained metadata using a trained machine learning, ML, model;
determining whether the associated confidence level is greater than or equal to a pre-defined confidence level; and
applying the generated at least one classification label to the data item when the generated at least one classification label has an associated confidence level that is greater than or equal to the pre-defined confidence level.

2. The method as claimed in claim 1 wherein generating at least one classification label for the data item using a trained machine learning, ML, model comprises:
determining a cluster from a plurality of pre-defined clusters of data items, wherein the data item is more similar to the data items in the determined cluster than other clusters.

3. The method as claimed in claim 2 wherein determining a cluster comprises:
identifying a cluster from the plurality of pre-defined clusters using the generated at least one embedding vector; and
comparing metadata of data items in the identified cluster to the obtained metadata.

4. The method as claimed in claim 3 wherein determining a cluster comprises:
using the identified cluster as the determined cluster when the obtained metadata is similar to the metadata of the data items in the identified cluster.

5. The method as claimed in claim 4 wherein generating at least one classification label for the data item using a trained machine learning, ML, model comprises:
retrieving at least one classification label associated with the identified cluster.

6. The method as claimed in claim 3 wherein determining a cluster comprises:
identifying an alternative cluster from the plurality of pre-defined clusters using the obtained metadata when the obtained metadata is dissimilar to the metadata of the data items in the identified cluster.

7. The method as claimed in claim 6 wherein generating at least one classification label for the data item using a trained machine learning, ML, model comprises:
retrieving at least one classification label associated with the identified alternative cluster.

8. The method as claimed in claim 2 wherein determining a cluster comprises using a clustering algorithm of the trained ML model.

9. The method as claimed in claim 8 wherein using a clustering algorithm comprises using any one of: a data clustering algorithm, a k-means clustering algorithm, and a density-based spatial clustering algorithm.

10. The method as claimed in claim 2 wherein generating a confidence level for each classification label comprises generating a confidence level that
indicates how confident the trained ML model is that the data item belongs in the determined cluster.

11. The method as claimed in claim 1 wherein determining whether the generated at least one classification label has an associated confidence level that is greater than or equal to a pre-defined confidence level comprises comparing the associated confidence level with a pre-defined confidence level that is defined for the environment.

12. The method as claimed in claim 1 wherein when the data item is newly modified, applying the generated at least one classification label to the data item comprises replacing any previous label applied to the data item with the generated at least one classification label.

13. The method as claimed in claim 1 wherein when the data item is newly modified, applying the generated at least one classification label to the data item comprises applying the generated at least one classification label in addition to any previous label applied to the data item.

14. The method as claimed in claim 1 wherein when the generated at least one classification label is determined to have an associated confidence level that is less than a pre-defined confidence level, the method comprises:
discarding the generated at least one classification label.

15. A computer-implemented method for training a machine learning, ML, model to autonomously classify uncategorised data items within an environment, the method comprising:
obtaining a training dataset comprising a plurality of labelled data items from data sources within the environment, and metadata for each labelled data item;
generating at least one embedding vector for each labelled data item, wherein the at least one embedding vector represents content of the data item; and
training the ML model to:
cluster the plurality of labelled data items into a plurality of clusters, using the at least one embedding vector of each labelled data item and metadata for each labelled data item, wherein each cluster contains a subset of the plurality of labelled data items that are more similar to each other than to the labelled data items in other clusters.

16. The method as claimed in claim 15 wherein training the ML model to cluster the plurality of labelled data items comprises:
comparing, for each cluster, labels of each labelled data item in the cluster to determine whether the labels of each labelled data item in the cluster is the same; and
training the ML model to generate clusters containing labelled data items with the same labels.

17. A computer-implemented method for autonomously controlling actions performed with respect to a data item within an environment, the method comprising:
obtaining, from a data source within the environment, a data item that is newly created or newly modified;
generating at least one embedding vector for the data item, wherein the at least one embedding vector represents content of the data item;
obtaining metadata for the data item;
generating at least one classification label for the data item together with an associated confidence level for each classification label, by processing the generated at least one embedding vector and obtained metadata using a trained machine learning, ML, model;
determining whether the generated at least one classification label has an associated confidence level that is greater than or equal to a pre-defined confidence level;
applying the generated at least one classification label to the data item when the generated at least one classification label has an associated confidence level that is greater than or equal to the pre-defined confidence level; and
controlling an action performed with respect to the data item based on the applied generated at least one classification label.

18. The method as claimed in claim 17 wherein controlling an action performed with respect to the data item comprises:
retrieving, using each applied classification label, at least one data management policy from a stored plurality of data management policies; and
controlling an action performed with respect to the data item using the retrieved at least one data management policy.

19. The method as claimed in claim 18 wherein:
the retrieved at least one data management policy specifies a location where data items having the applied classification label are to be stored, and controlling an action performed with respect to the data item comprises storing the data item in the location specified by the retrieved data management policy; and/or
the retrieved at least one data management policy specifies a security level to be applied to data items having the applied classification label, and controlling an action performed with respect to the data item comprises applying the specified security level to the data item.

20. The method as claimed in claim 18 wherein:
the retrieved at least one data management policy specifies that data items having the applied classification label cannot be transmitted outside of the environment, and controlling an action performed with respect to the data item comprises blocking the transmission of the data item outside of the environment, and/or
the retrieved at least one data management policy specifies that data items having the applied classification label must be edited before transmission outside of the environment, and controlling an action performed with respect to the data item comprises editing the data item prior to transmission of the data item outside of the environment.
